(19) United States
(12) Patent Application Publication
(10) Pub. No.: US 2021/0056818 A1
(43) Pub. Date: Feb. 25, 2021

(54) REGISTRATION SYSTEM, REGISTRATION METHOD, AND PROGRAM

(71) Applicant: NEC Corporation, Tokyo (JP)

(72) Inventor: Shinya YAMASAKI, Tokyo (JP)

(73) Assignee: NEC Corporation, Tokyo (JP)

(21) Appl. No.: 16/982,830

(22) PCT Filed: Oct. 18, 2018
(86) PCT No.: PCT/JP2018/038801

§ 371 Date: Sep. 21, 2020

(30) Foreign Application Priority Data
Mar. 22, 2018 (JP) 2018-054102

(51) Int. Cl. G07G 1/00; G07G 1/01; G07G 1/12; G06K 9/00

(52) U.S. Cl. CPC G07G 1/0036; G06K 9/00201; G07G 1/12; G07G 1/01

(57) ABSTRACT

The present invention provides a registration system (10) including a detection unit (11) that detects an object in a captured image obtained by a camera imaging a placing surface of a table on which a product is placed, a recognition unit (12) that recognizes which product the object is, a display unit (13) that displays information for determining the object which cannot be recognized and a product candidate for the object on the display, a selection input reception unit (15) that receives a selection input for selecting one of the product candidates, and a registration unit (14) that registers the recognized product and the selected product candidate as checkout targets.

### TECHNICAL FIELD

The present invention relates to a registration system, a registration method, and a program.

### BACKGROUND ART

A technology of recognizing a product with image analysis and registering the product as a checkout target is examined. Technologies in the related art are disclosed in Patent Documents 1 to 5.

Patent Document 1 discloses an apparatus which executes a process of analyzing an image of a product generated in response to an operation of holding one product over a reading window to recognize the product, and then displays a plurality of product candidates selected based on a reliability in a display form according to the reliability and registers a product specified from the displayed product candidates as a checkout target.

Patent Documents 2 and 3 disclose an apparatus which executes a process of analyzing an image of a product generated in response to an operation of holding one product over a reading window to recognize the product, and then displays a plurality of product candidates in a case where a reliability is less than a reference value and registers a product specified from the product candidates as a checkout target.

Patent Document 4 discloses an apparatus which executes a process of analyzing an image of a product on a belt conveyor to recognize the product, and then displays a product candidate on a display in a case where a reliability is within a predetermined range and lights up a display lamp when the product moves to the vicinity of a terminal, and registers a product specified from the product candidates as a checkout target.

Patent Document 5 discloses an apparatus which images a product placed on a table with a camera, recognizes the product by pattern matching based on a feature value of an appearance of the product, and registers the recognized product as a checkout target.

### RELATED DOCUMENT

### Patent Document

[Patent Document 1] Japanese Patent Application Publication No. 2015-41157
[Patent Document 2] Japanese Patent Application Publication No. 2015-138350
[Patent Document 3] Japanese Patent No. 5748880
[Patent Document 4] Japanese Patent Application Publication No. 2016-110538
[Patent Document 5] Japanese Patent Application Publication No. 2017-220206

### SUMMARY OF THE INVENTION

### Technical Problem

In a technology capable of collectively imaging a plurality of products and recognizing the plurality of products included in an image, a means which registers a product which cannot be recognized by image analysis as a checkout target is desired.

The present inventor examines a use of a technology of displaying a product candidate for a product which cannot be recognized by image analysis and registering a product specified from the product candidate as a checkout target. As a result, the following problems are found. In a case of the technology capable of collectively imaging a plurality of products and recognizing the plurality of products included in an image, there is a possibility that there are a plurality of products which cannot be recognized by image analysis. In a case where a product candidate is displayed in a situation in which there are the plurality of products which cannot be recognized by image analysis, a user cannot recognize which product the product candidate is. Patent Documents 1 to 3 and Patent Document 5 neither describe nor suggest a means which solves the problem.

In the technology disclosed in Patent Document 4, by displaying the product candidate on the display and lighting up the display lamp when the product moves to the vicinity of the terminal, it clearly indicates which product candidate the displayed product candidate is displayed as. However, the means is a technology based on the premise that the product is moved by a belt conveyor, and cannot be adopted in a configuration not using the belt conveyor.

An object of the present invention is to provide a means which registers a product which cannot be recognized by image analysis as a checkout target, in a technology capable of collectively imaging a plurality of products and recognizing the plurality of products included in an image.

### Solution to Problem

According to the present invention, there is provided a registration system including a detection unit that detects an object in a captured image obtained by a camera imaging a placing surface of a table on which a product is placed; a recognition unit that recognizes which product the object is; a display unit that displays information for determining the object that cannot be recognized and a product candidate for the object on a display; a selection input reception unit that receives a selection input for selecting one from the product candidates; and a registration unit that registers the recognized product and the selected product candidate as checkout targets.

In addition, according to the present invention, there is provided a registration method executed by a computer, the method including: a detection step of detecting an object in a captured image obtained by a camera imaging a placing surface of a table on which a product is placed; a recognition step of recognizing which product the object is; a display step of displaying information for determining the object that cannot be recognized and a product candidate for the object on a display; a selection input reception step of receiving a selection input for selecting one from the product candidates; and a registration step of registering the recognized product and the selected product candidate as checkout targets.

In addition, according to the present invention, there is provided a program causing a computer to function as: a detection unit that detects an object in a captured image obtained by a camera imaging a placing surface of a table on which a product is placed; a recognition unit that recognizes which product the object is; a display unit that displays information for determining the object that cannot be recognized and a product candidate for the object on a display; a selection input reception unit that receives a selection input for selecting one from the product candidates; and a registration unit that registers the recognized product and the selected product candidate as checkout targets.

### Advantageous Effects of Invention

According to this invention, in a technology capable of collectively imaging a plurality of products and recognizing the plurality of products included in an image, a product which cannot be recognized by image analysis is registered as a checkout target.

### BRIEF DESCRIPTION OF THE DRAWINGS

The above objects and other objects, features and advantages will become more apparent from the following description of the preferred example embodiments and the accompanying drawings.

FIG. 1 is a diagram illustrating a hardware configuration example of a registration system according to the present example embodiment.

FIG. 2 is a diagram illustrating an example of a functional block diagram of the registration system 10 according to the present example embodiment.

FIG. 3 is a diagram illustrating an example of a hardware configuration of a computer 5 according to the present example embodiment.

FIG. 4 is a diagram schematically illustrating an example of information output to a second display 2 by the registration system 10 according to the present example embodiment.

FIG. 5 is a diagram schematically illustrating an example of information output to a first display 7 by the registration system 10 according to the present example embodiment.

FIG. 6 is a flowchart illustrating an example of a flow of a process of the registration system 10 according to the present example embodiment.

FIG. 7 is a flowchart illustrating another example of the flow of the process of the registration system 10 according to the present example embodiment.

FIG. 8 is a diagram schematically illustrating another example of the information output to the first display 7 by the registration system 10 according to the present example embodiment.

FIG. 9 is a diagram illustrating an example of another functional block diagram of the registration system 10 according to the present example embodiment.

FIG. 10 is a diagram schematically illustrating still another example of the information output to the first display 7 by the registration system 10 according to the present example embodiment.

FIG. 11 is a diagram schematically illustrating still another example of the information output to the first display 7 by the registration system 10 according to the present example embodiment.

FIG. 12 is a diagram schematically illustrating still another example of the information output to the first display 7 by the registration system 10 according to the present example embodiment.

FIG. 13 is a diagram schematically illustrating still another example of the information output to the first display 7 by the registration system 10 according to the present example embodiment.

FIG. 14 is a diagram schematically illustrating still another example of the information output to the first display 7 by the registration system 10 according to the present example embodiment.

FIG. 15 is a diagram schematically illustrating still another example of the information output to the first display 7 by the registration system 10 according to the present example embodiment.

FIG. 16 is a diagram schematically illustrating still another example of the information output to the first display 7 by the registration system 10 according to the present example embodiment.

FIG. 17 is a diagram schematically illustrating still another example of the information output to the first display 7 by the registration system 10 according to the present example embodiment.

FIG. 18 is a diagram schematically illustrating still another example of the information output to the first display 7 by the registration system 10 according to the present example embodiment.

### DESCRIPTION OF EMBODIMENTS

### First Example Embodiment

First, a hardware configuration example and an outline of a process of a registration system according to the present example embodiment will be described.

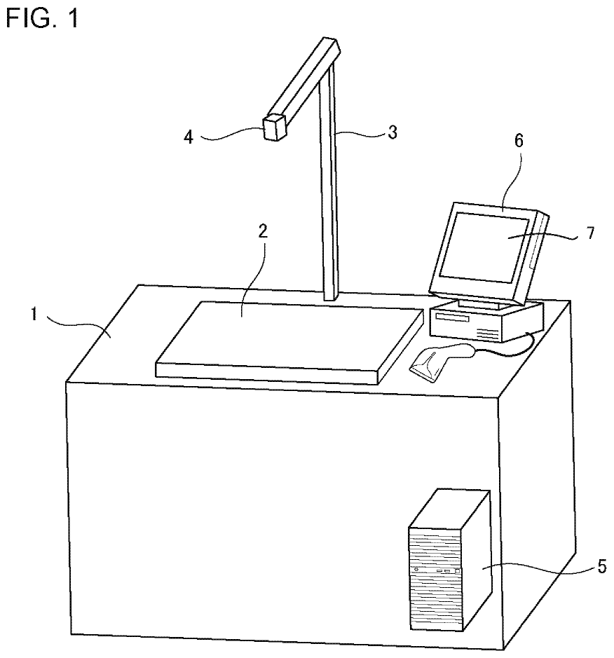

As illustrated in FIG. 1, the registration system includes a placing table 1, the second display 2, an operation terminal 6 having the first display 7, a computer 5, and a camera 4. In the illustrated example, the camera 4 is attached to a column 3. Note that, the illustrated configuration example is merely an example, and the example embodiment is not limited to this.

The camera 4 and the computer 5 are configured to be able to communicate with each other in a wired and/or wireless manner. In addition, the computer 5 and the operation terminal 6 are configured to be able to communicate with each other in a wired and/or wireless manner. Further, the second display 2 and the computer 5 are configured to be able to communicate with each other in a wired and/or wireless manner.

The second display 2 constitutes a part of the placing table 1 and displays various types of information. One or a plurality of products to be checked out are placed on the placing table 1, more specifically on the second display 2. The camera 4 is installed at a position at which the second display 2 is imaged from above. An image generated by the camera 4 is transmitted to the computer 5. The computer 5 analyzes the image, detects an object existing in the image, and recognizes which product the detected object is. The recognized product is registered as a checkout target. The product registered as the checkout target is displayed on the first display 7 of the operation terminal 6.

In addition, the computer 5 displays information (first information) determining one of the detected objects (objects for which products are not recognized) not registered as checkout targets, on the first display 7. Further, the computer 5 displays product candidates for the object determined by the first information, on the first display 7. The operation terminal 6 receives an operation of selecting one of the product candidates displayed on the first display 7 from a user. The computer 5 recognizes the object determined by the first information as the product candidate selected by the user and registers the product.

The registration system 10 according to the present example embodiment makes it possible to clearly indicate for which product (object) the displayed product candidate is displayed as a candidate.

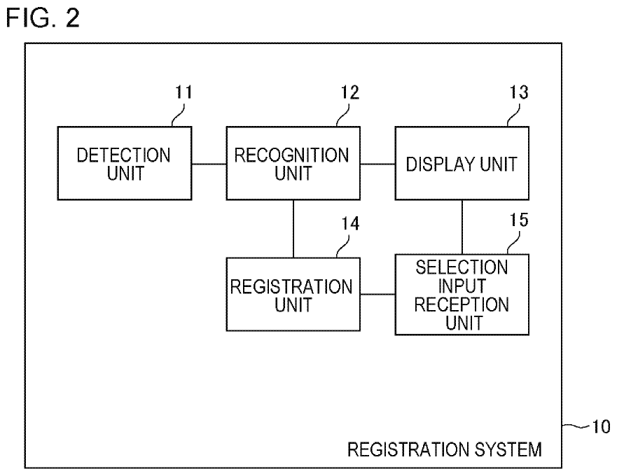

Hereinafter, a configuration of the registration system 10 according to the present example embodiment will be described in detail. FIG. 2 illustrates an example of a functional block diagram of the registration system 10 according to the present example embodiment. As illustrated, the registration system 10 includes a detection unit 11, a recognition unit 12, a display unit 13, a registration unit 14, and a selection input reception unit 15. The registration system may be constituted by a plurality of apparatuses physically and/or logically separated, or may be constituted physically and/or logically by one apparatus. In a case of being constituted by the plurality of physically and/or logically separated apparatuses, the plurality of apparatuses are configured to be able to communicate with each other in a wired and/or wireless manner.

Each functional unit included in the registration system 10 is realized by any combination of hardware and software of any computer based on a central processing unit (CPU), a memory, a program loaded in the memory, a storage unit (in addition to the program stored in advance from a stage of shipping the apparatus, a program downloaded from a storage medium such as a compact disc (CD) or a server on the internet) such as a hard disc storing the program, and a network connection interface. Those skilled in the art understand that there are various modification examples to a realization method and the apparatus.

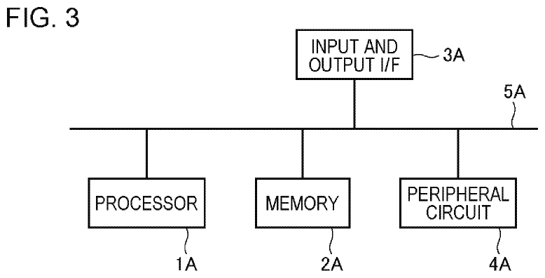

FIG. 3 is a block diagram illustrating a hardware configuration of the computer 5. As illustrated in FIG. 3, the computer 5 has a processor 1A, a memory 2A, an input and output interface 3A, a peripheral circuit 4A, and a bus 5A. The peripheral circuit 4A includes various modules. The peripheral circuit 4A may not be provided. Note that, in a case where the computer 5 is constituted by a plurality of physically and/or logically separated apparatuses, each apparatus can have the hardware configuration.

The bus 5A is a data transmission line through which the processor 1A, the memory 2A, the peripheral circuit 4A and, the input and output interface 3A transmit and receive data to and from one another. The processor 1A is an arithmetic processing apparatus such as a central processing unit (CPU) or a graphics processing unit (GPU). The memory 2A is a memory such as a random access memory (RAM) or a read only memory (ROM), for example. The input and output interface 3A includes an interface for acquiring information from an input apparatus (for example, a keyboard, a mouse, a microphone, a camera, or the like), an external apparatus, an external server, an external sensor, and the like and an interface for outputting the information from an output apparatus (for example, a display, a speaker, a printer, an emailer, or the like), the external apparatus, the external server, and the like. The processor 1A can output a command to each module and perform arithmetic based on the operation result.

Returning to FIG. 2, a functional configuration of each functional unit will be described.

The detection unit 11 analyzes an image obtained by imaging a placing surface of a table on which a product is placed with the camera, and detects an object in the image. In the present example embodiment, the detection unit 11 analyzes an image obtained by the camera 4 capturing an image of a display surface (a surface on which information is displayed) of the second display 2 illustrated in FIG. 1. For example, the detection unit 11 can detect an area in which an object exists, by performing binarization, a contour extraction process, and the like on the image.

Further, the detection unit 11 can determine a position in an image of each detected object. The position in the image is indicated with a two-dimensional coordinate system (hereinafter, an “image coordinate system”) having any point as an origin and any directions as an x-axis and a y-axis in the image.

Returning to FIG. 2, the recognition unit 12 analyzes an image and recognizes which product an object detected by the detection unit 11 is. The recognition unit 12 collates an appearance feature (a feature of an area in which the object exists in the image) appearing in the image of the object detected by the detection unit 11 with an appearance feature of each of a plurality of pre-registered products (reference information) to determine which product the object is (product recognition). Examples of the appearance feature of the product include colors, surface irregularities, shapes, and the like, but the example embodiment is not limited to this.

For example, the recognition unit 12 computes a similarity with the detected object, for each product for which the appearance feature is registered. In a case where there is one product having the similarity satisfying a condition (for example, a first reference value or more), the recognition unit 12 can output a recognition result that the object is the product.

On the other hand, in a case where there is no product having the similarity satisfying the condition (for example, the first reference value or more), or there are a plurality of products having the similarity satisfying the condition (for example, the first reference value or more), the recognition unit 12 can output a recognition result that “the object cannot be recognized”.

The display unit 13 displays various types of information on the first display 7 of the operation terminal 6 and the second display 2.

For example, the display unit 13 can display information indicating a product (for example, a product recognized by the recognition unit 12) registered as a checkout target, on the second display 2. In addition, the display unit 13 can display information indicating a product which is not registered as the checkout target (for example, a product which is not recognized by the recognition unit 12), on the second display 2.

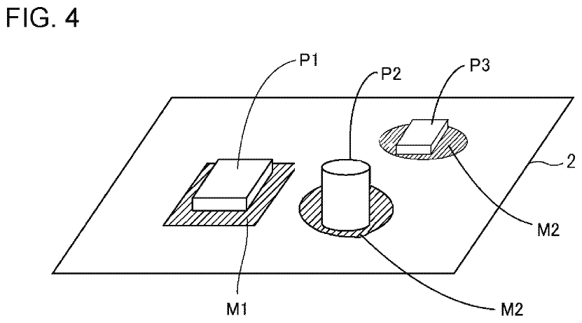

FIG. 4 schematically illustrates an example of information displayed on the second display 2 by the display unit 13. In the illustrated example, a mark M1 is displayed at a placement position of the product registered as the checkout target (for example, the product recognized by the recognition unit 12). Further, a mark M2 is displayed at a placement position of the product which is not registered as the checkout target (for example, the product which is not recognized by the recognition unit 12).

The display unit 13 holds in advance a conversion rule for converting “coordinates in the image coordinate system” into “coordinates in a coordinate system of the second display 2”. The “coordinates of the image coordinate system” are represented by a coordinate system in which any position is defined as an origin and any directions are defined as an x-axis direction and a y-axis direction in the image. The “coordinates of the coordinate system of the second display 2” are represented by a coordinate system in which any position is defined as an origin and any directions are defined as an x-axis direction and a y-axis direction within a display area of the second display 2.

The display unit 13 converts coordinates of the image coordinate system of each object determined by the detection unit 11 into the coordinates of the coordinate system of the second display 2, based on the conversion rule. The display unit 13 displays various types of information (the marks M1 and M2, and the like) so as to surround coordinates of the coordinate system of the second display 2 obtained by the conversion or be close to the coordinates.

Note that, the displayed information may be other information such as characters, numbers, and symbols. Further, in the illustrated example, the information is displayed so as to include the placement position of the product, but the information may be displayed near the placement position. Further, the mark M1 and the mark M2 are distinguished from each other by a difference in shape, but the mark M1 and the mark M2 may be distinguished from each other by a difference in other display form such as a difference in color and a difference in shade.

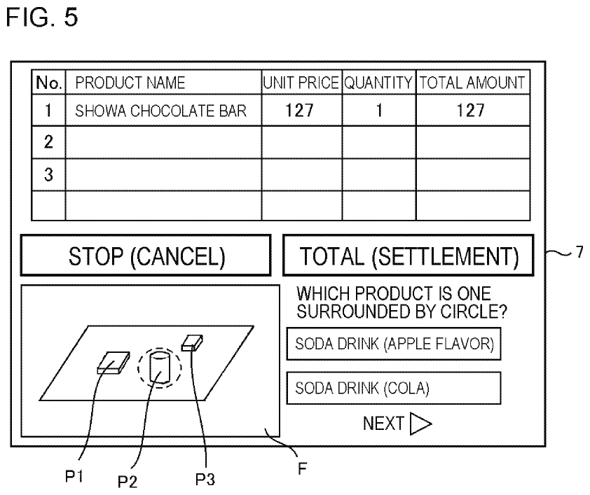

In addition, as illustrated in FIG. 5, the display unit 13 displays information (first information) for determining one of the objects not registered as the checkout targets (for example, an object which is not recognized by the recognition unit 12) and product candidates for the object determined by the first information, on the first display 7.

In the example illustrated, the display unit 13 displays an image (a captured image) F generated by the camera 4 on the first display 7, and displays the first information (a dotted circle) for determining one of the objects which cannot be recognized by the image analysis, on the image F. In addition, “soda drink (apple flavor)” and “soda drink (cola)” are displayed as the product candidates for the object determined by the first information.

The product candidate is determined based on a recognition result by the recognition unit 12. For example, in a case where there is a recognition result that “the object cannot be recognized” as a result that there are a plurality of products having a similarity satisfying a condition (for example, the first reference value or more), the plurality of products having the similarity satisfying the condition (for example, the first reference value or more) may be set as product candidates.

In addition, in a case where there is a recognition result that “the object cannot be recognized” as a result that there is no product having the similarity satisfying the condition (for example, the first reference value or more), one or a plurality of products having a similarity satisfying another condition (for example, the second reference value or more (the first reference value>the second reference value)) may be set as the product candidates.

Returning to FIG. 2, the selection input reception unit 15 receives a selection input from the user for selecting one of the product candidates displayed on the display unit 13. For example, the first display 7 is a touch panel display, and the selection input reception unit 15 receives a selection input for selecting one product candidate by a touch operation on the first display 7. Note that, the selection input reception unit 15 may receive the selection input via another input apparatus such as a physical button or a microphone.

The registration unit 14 registers product information of a product as a checkout target. For example, the registration unit 14 acquires product information (for example, a price, a product name, and the like) of the product recognized by the recognition unit 12 from a product master, and registers the product information. Further, the registration unit 14 acquires product information of the product candidate selected by the selection input received by the selection input reception unit 15 from the product master, and registers the product information. As illustrated in FIG. 5, the display unit 13 can display a list of products as the checkout targets registered by the registration unit 14, on the first display 7. In the example illustrated, “Showa chocolate bar” is displayed as the checkout target.

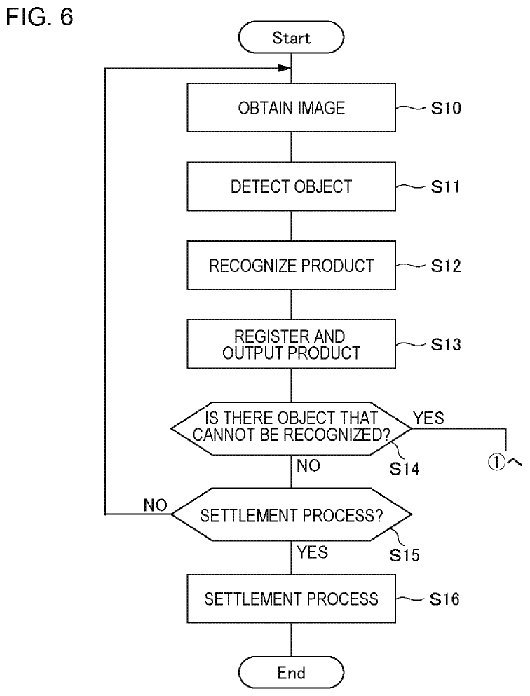

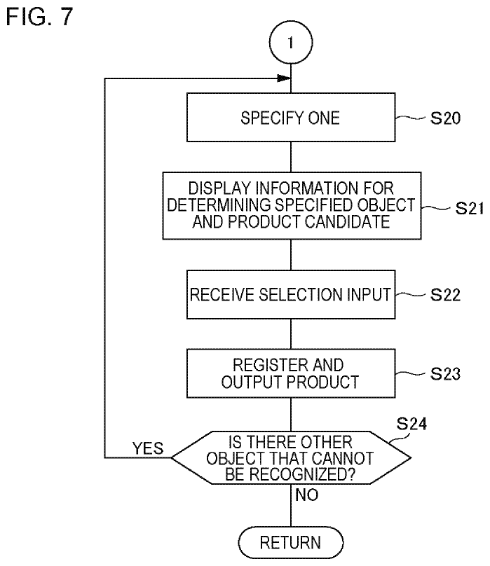

Next, an example of a flow of a process of the registration system 10 according to the present example embodiment will be described with reference to the flowcharts in FIGS. 6 and 7.

The user places a product to be checked out, for example, on the second display 2 in FIG. 1. The product placed on the second display 2 is imaged by the camera 4. An image generated by the camera 4 is transmitted to the computer 5.

Note that, the flow of the process will be described based on the following premise.
As illustrated in FIG. 4, three products P1 to P3 are placed on the second display 2.
The product P1 is detected by the detection unit 11 as an object and recognized by the recognition unit 12 as a product.
The products P2 and P3 are detected by the detection unit 11 as objects, but not recognized by the recognition unit 12 as products.

When acquiring an image generated by the camera 4 (S10), the detection unit 11 performs binarization, a contour extraction process, and the like on the image and detects an area in which an object exists to detect one or a plurality of objects in the image (S11). As described above, the detection unit 11 detects the products P1 to P3 illustrated in FIG. 4 as the objects.

Next, the recognition unit 12 recognizes which product each of the one or the plurality of objects detected in S11 is (S12). Specifically, the recognition unit 12 collates an appearance feature (a feature of an area in which the object in the image exists) appearing in the image of the detected object with an appearance feature of each of a plurality of pre-registered products (reference information) to determine which product the object is.

For example, the recognition unit 12 computes a similarity with the detected object, for each product for which the appearance feature is registered. In a case where there is one product having the similarity satisfying a condition (for example, a first reference value or more), the recognition unit 12 can output a recognition result that the object is the product.

On the other hand, in a case where there is no product having the similarity satisfying the condition (for example, the first reference value or more), or there are a plurality of products having the similarity satisfying the condition (for example, the first reference value or more), the recognition unit 12 can output a recognition result that “the object cannot be recognized”.

As described above, the recognition unit 12 recognizes the product P1 as a product. The recognition unit 12 does not recognize the products P2 and P3 as products.

In S13, the registration unit 14 acquires product information (for example, a price, a product name, and the like) of the product recognized in S12 from the product master, and registers the product information as a checkout target. Here, the registration unit 14 acquires product information of the product P1 from the product master, and registers the product information as the checkout target.

The display unit 13 displays a list of products registered as checkout targets on the first display 7, as illustrated in FIG. 5. In the example illustrated in FIG. 5, only the product P1 (“Showa chocolate bar”) is registered as the checkout target.

Note that, as illustrated in FIG. 4, the display unit 13 can display information (the mark M1 in FIG. 4) indicating the product P1 (the object recognized as the product in S12) registered as the checkout target on the second display 2. In addition, the display unit 13 can display information (the mark M2 in FIG. 4) indicating the products P2 and P3 (the objects not recognized as the products in S12) which are not registered as the checkout targets on the second display 2.

In S14, it is determined whether or not there is an object which is not recognized by the recognition unit 12 as the product, among the objects detected in S11. In a case where there is no object (No in S14), the process proceeds to S15. In a case where there is the object (Yes in S14), the process proceeds to the flow in FIG. 7. As described above, the recognition unit 12 does not recognize the products P2 and P3 as the products. Therefore, the process proceeds to the flow in FIG. 7.

In the flow in FIG. 7, first, one of the objects which are not recognized by the recognition unit 12 as the products is specified (S20). An order of the specification is a matter of design. Here, it is assumed that the product P2 (object) is specified.

In S21, as illustrated in FIG. 5, the display unit 13 displays the first information (the dotted circle) for determining the specified object and the product candidate for the object, on the first display 7. In the example illustrated, the display unit 13 displays the image F generated by the camera 4 on the first display 7, and displays the first information (the dotted circle) for determining one (the product P2) of the objects (the products P2 and P3) which cannot be recognized by the image analysis, on the image F. In addition, “soda drink (apple flavor)” and “soda drink (cola)” are displayed as the product candidates for the object determined by the first information.

In S22, the selection input reception unit 15 receives a selection input for selecting one of the product candidates displayed on the first display 7. Here, it is assumed that “soda drink (apple flavor)” is selected.

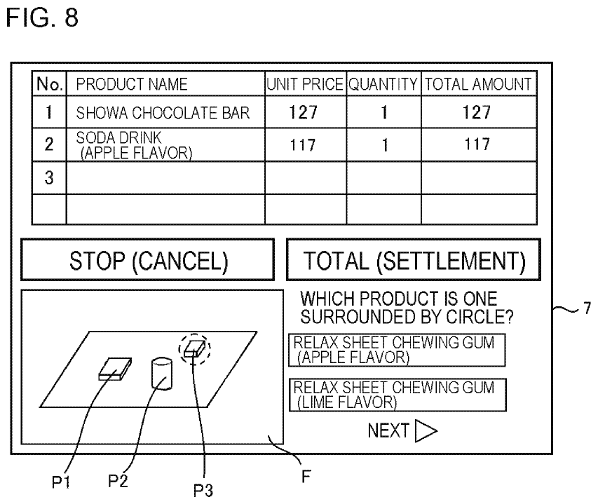

In S23, the registration unit 14 acquires product information (for example, a price, a product name, and the like) of the product candidate selected in S22 from the product master, and registers the product information as a checkout target. As illustrated in FIG. 8, the display unit 13 adds the product candidate to the list of the products registered as the checkout targets.

In S24, it is determined whether there is an object which is not recognized by the recognition unit 12 as the product and is not specified in S20. In a case where there is no object (No in S24), the flow is terminated and the process proceeds to S15 in FIG. 6. In a case where there is the object (Yes in S24), the process returns to S20 and another object is newly specified. Here, since the product P3 is not specified yet, the process returns to S20.

In S20, the product P3 (object) is newly specified. In S21, as illustrated in FIG. 8, the display unit 13 displays the first information (the dotted circle) for determining the specified object on the image F of the first display 7. Further, the display unit 13 displays product candidates for the newly specified object on the first display 7, as illustrated in FIG. 8. Hereinafter, the process is performed in the same manner.

Returning to FIG. 6, when there is no input to start a settlement process (No in S15), the process returns to S10 and the same process is repeated. Note that, based on, for example, a time-series change of the image, the detection unit 11 can distinguish an object newly placed on the second display 2 from an object which is still placed on the second display 2. When the new object is detected, the registration unit 14 registers the new product as a checkout target, based on a recognition result for the object in S12 or a selection input content in S22 in FIG. 7.

When there is the input to start the settlement process (Yes in S16), the registration system 10 performs the settlement process. For example, the registration system 10 may receive an input of cash as payment of a total payment amount computed based on the registered product, and may output a change or a receipt as necessary. Further, the registration system 10 may receive an input of credit card information, communicate with a system of a credit company, and perform a payment process. In addition, the registration system 10 may transmit information for the settlement process (information indicating the registered product, the total payment amount, and the like) to another settlement apparatus. In addition, the registration system 10 may receive an input of a tendered amount tendered by a customer, compute a change amount based on the input amount, displays the change amount on the display (for example, the first display 7), or pay out the computed change amount.

The registration system 10 according to the present example embodiment described above makes it possible to image a plurality of products collectively, recognize the plurality of products included in an image, and register the recognized plurality of products as checkout targets. Therefore, it is possible to improve efficiency of a work of registering the product of the checkout target.

Further, in a case where there are products which cannot be recognized by image analysis, it is possible to display information determining one of the products and product candidates for the determined product. It is possible to register the one selected from the product candidates as the checkout target. In this manner, the registration system 10 according to the present example embodiment makes it possible to clearly indicate for which product (object) the displayed product candidate is displayed as a candidate. For this reason, the user can easily recognize the display contents and proceed with the work smoothly.

### Second Example Embodiment

The registration system 10 according to the present example embodiment is different from the first example embodiment in that an object determined by the first information (an object of which product candidates are displayed) can be changed to another object based on a user input.

An example of a hardware configuration of the registration system 10 according to the present example embodiment has the same manner as that of the first example embodiment.

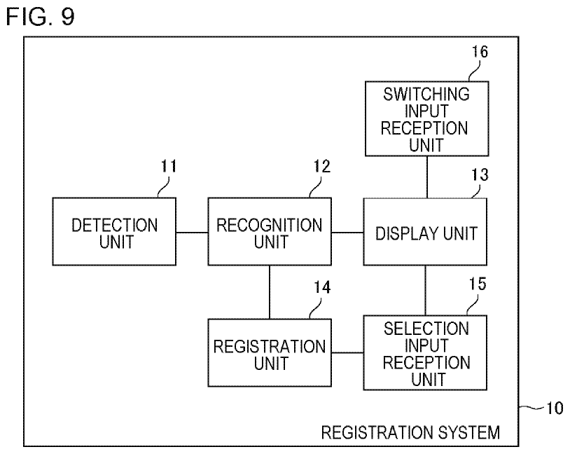

An example of a functional block diagram of the registration system 10 is illustrated in FIG. 9. As illustrated, the registration system 10 includes the detection unit 11, the recognition unit 12, the display unit 13, the registration unit 14, the selection input reception unit 15, and a switching input reception unit 16. Configurations of the detection unit 11, the recognition unit 12, the registration unit 14, and the selection input reception unit 15 have the same manner as those in the first example embodiment.

The switching input reception unit 16 receives a switching input for switching an object determined by the first information (an object of which product candidates are displayed). The switching input operation may be, for example, an operation of tapping an area in which any object is displayed on the image F illustrated in FIG. 5. In addition, although not illustrated, for example, a button associated with information such as “switch target of which product candidates are displayed” is displayed on the first display 7, and the object (the object for which the product candidates are displayed) determined by the first information may be switched in order according to the tap operation on the button. Note that, a content of the touch operation is a matter of design. In addition, the switching input may be received via another input apparatus such as a physical button or a microphone provided on the operation terminal 6.

The display unit 13 switches the object determined by the first information according to the switching input. In addition, the display unit 13 switches the product candidates displayed on the first display 7 according to the switching input.

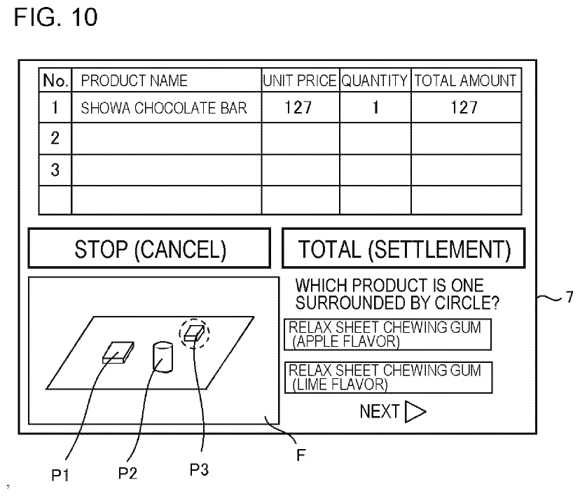

For example, in the state illustrated in FIG. 5, in a case where there is an input to switch the object (the object for which the product candidates are displayed) determined by the first information (the dotted circle) from the product P2 to the product P3, the display unit 13 changes the displayed content as illustrated FIG. 10. In FIG. 10, a dotted circle (first information) is displayed at a placement position of the product P3, and the dotted circle (the first information) is not displayed at a placement position of the product P2. Further, the displayed product candidate is a product candidate for the product P3. That is, in the transition from FIG. 5 to FIG. 10, a display position of the dotted circle (the first information) is switched. Further, in the transition from FIG. 5 to FIG. 10, the contents of the displayed product candidates are switched.

Other configurations of the display unit 13 have the same manner as that of the first example embodiment.

The registration system 10 according to the present example embodiment described above allows the same advantageous effect as the first example embodiment to be achieved. Further, the registration system 10 according to the present example embodiment allows a display target of the product candidates to be switched according to the user input. The user can proceed with the process in his or her favorite order.

### Third Example Embodiment

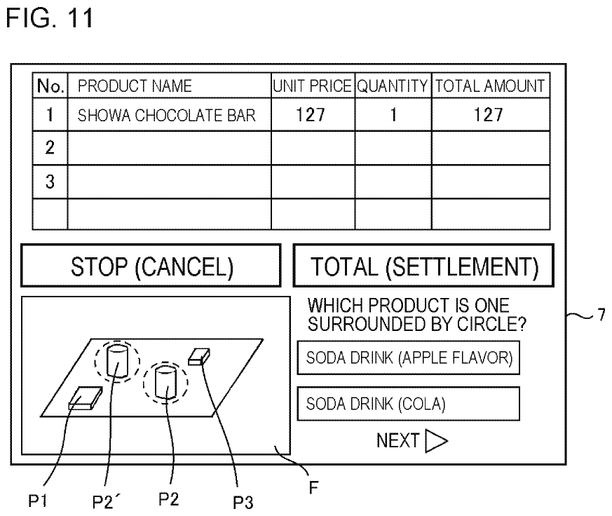

As illustrated in FIG. 11, the registration system 10 according to the present example embodiment is different from the first and second example embodiments in that M (M is equal to or more than two) objects (objects for which product candidates are displayed) are determined by the first information (a dotted circle), and when a selection input for selecting one of product candidates is received in this state, the selected product candidate for the M objects is registered as checkout targets.

An example of a hardware configuration of the registration system 10 according to the present example embodiment has the same manner as that of the first and second example embodiments.

An example of a functional block diagram of the registration system 10 is illustrated in FIG. 9. As illustrated, the registration system 10 includes the detection unit 11, the recognition unit 12, the display unit 13, the display unit 13, the registration unit 14, the selection input reception unit 15, and the switching input reception unit 16. Configurations of the detection unit 11, the recognition unit 12, and the selection input reception unit 15 have the same manner as those in the first and second example embodiments.

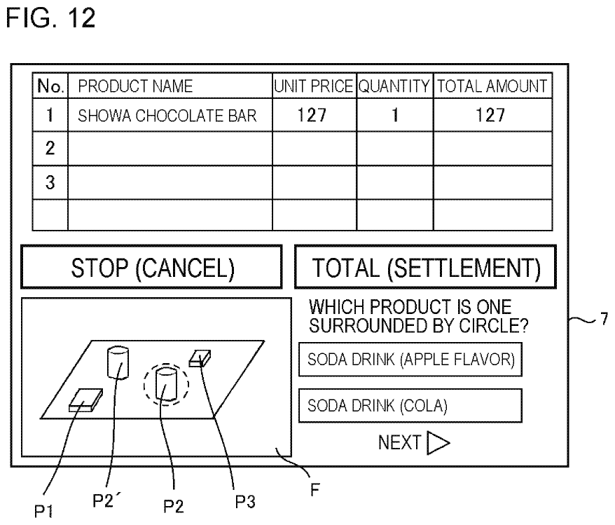

The switching input reception unit 16 receives a user input (a grouping input) of displaying the first information which determines M objects (M is equal to or more than two) of the objects which are not recognized by the recognition unit 12 as the products. For example, the grouping input may be an operation of tapping, on the image F illustrated in FIG. 12, a display area of the product P2 on which the first information (the dotted circle) is displayed and a display area of another product (a product P2′) at the same time. Note that, a content of the touch operation is a matter of design.

The display unit 13 switches the object determined by the first information according to the grouping input. For example, in the state illustrated in FIG. 12, when the user input of displaying the first information which determines the product P2 and the product P2′ is received, the display unit 13 changes the display content as illustrated in FIG. 11. In FIG. 11, the first information (the dotted circle) is displayed on both the product P2 and the product P2′.

The display unit 13 displays the product candidates for the plurality of objects determined by the first information, on the first display 7. For example, the display unit 13 can display a product which is the product candidate for one of the plurality of objects determined by the first information, as a product candidate.

When the selection input reception unit 15 receives the selection input of selecting one of the product candidates in a state in which the first information for determining the M objects (M is equal to or more than two) is displayed, the registration unit 14 registers the selected product candidate for the M objects as the checkout targets.

Other configurations of the display unit 13, the display unit 13, and the registration unit 14 have the same manner as those in the first and second example embodiments.

The registration system 10 according to the present example embodiment described above allows the same advantageous effect as the first and second example embodiments to be achieved. Further, the registration system 10 according to the present example embodiment makes, in a case where a plurality of identical products are not recognized as products and are not registered as checkout targets, it possible to lump the products together and perform an input of specifying a product candidate. As a result, work efficiency of the user is improved.

### Fourth Example Embodiment

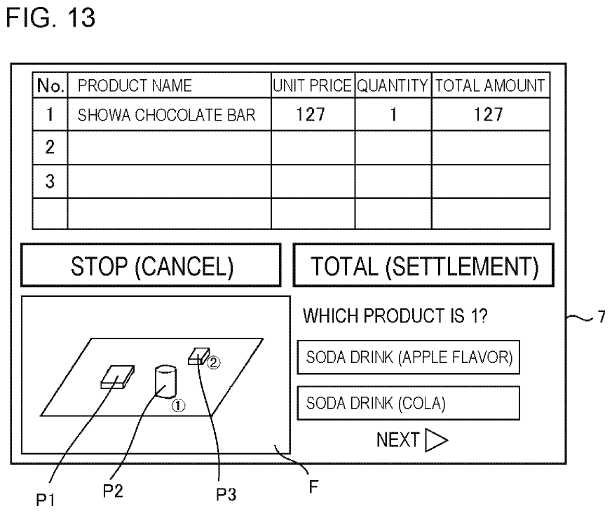

As illustrated in FIG. 13, the registration system 10 according to the present example embodiment is different from the first to third example embodiments in that identification information (circled numbers) issued corresponding to each as the first information for determining an object which is not recognized by the recognition unit 12 as a product is displayed.

An example of a hardware configuration of the registration system 10 according to the present example embodiment has the same manner as that of the first to third example embodiments.

An example of a functional block diagram of the registration system 10 is illustrated in FIG. 2 or 9. As illustrated, the registration system 10 includes the detection unit 11, the recognition unit 12, the display unit 13, the registration unit 14, the selection input reception unit 15, and may further include the switching input reception unit 16. Configurations of the detection unit 11, the recognition unit 12, the registration unit 14, the selection input reception unit 15, and the switching input reception unit 16 have the same manner as those of the first to third example embodiments.

As illustrated in FIG. 13, the display unit 13 displays identification information issued corresponding to each as the first information for determining the object which is not recognized by the recognition unit 12 as the product, on the image F of the first display 7. By displaying the identification information, the display unit 13 distinguishably displays a plurality of objects which are not recognized as products by the recognition unit 12. Each piece of identification information is displayed close to each object. The identification information is information for identifying the object which is not recognized by the recognition unit 12 as the product. The identification information is configured with, for example, numbers, characters, marks, figures, and the like.

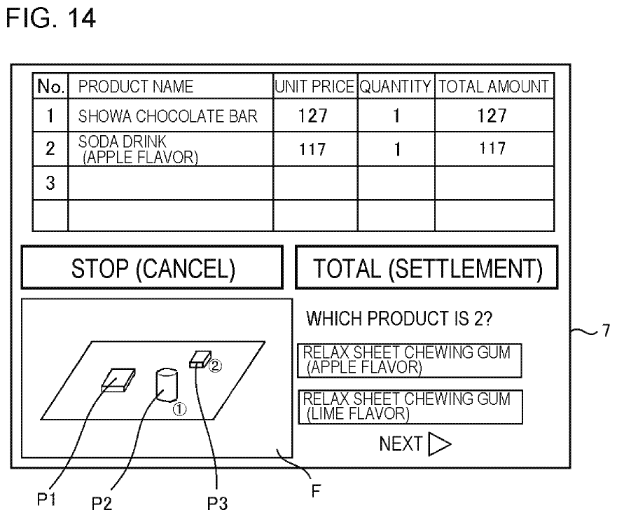

As illustrated in FIG. 13, the display unit 13 displays product candidates in association with each piece of identification information displayed as the first information. When “soda drink (apple flavor)” is selected in the state in FIG. 13, the selected product candidate is added to the checkout target as illustrated in FIG. 14. A product candidate for the object corresponding to another piece of identification information is newly displayed. In this manner, in a case where there are the plurality of objects which are not recognized by the recognition unit 12 as the products, the display unit 13 may sequentially display the product candidates for one object at a time.

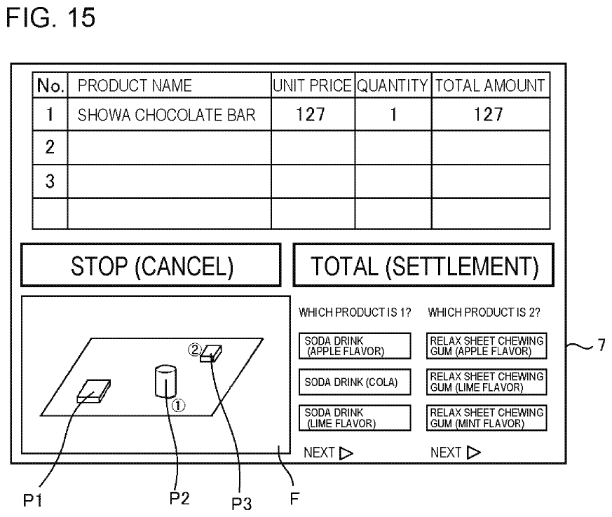

In addition, as illustrated in FIG. 15, in a case where there are the plurality of objects which are not recognized by the recognition unit 12 as the products, the display unit 13 may display the product candidates for each of the plurality of objects at the same time.

In this manner, the display unit 13 distinguishably displays the plurality of objects which cannot be recognized by image analysis, and displays each product candidate on the first display 7.

The registration system 10 according to the present example embodiment described above allows the same advantageous effect as the first to third example embodiments to be achieved.

### Fifth Example Embodiment

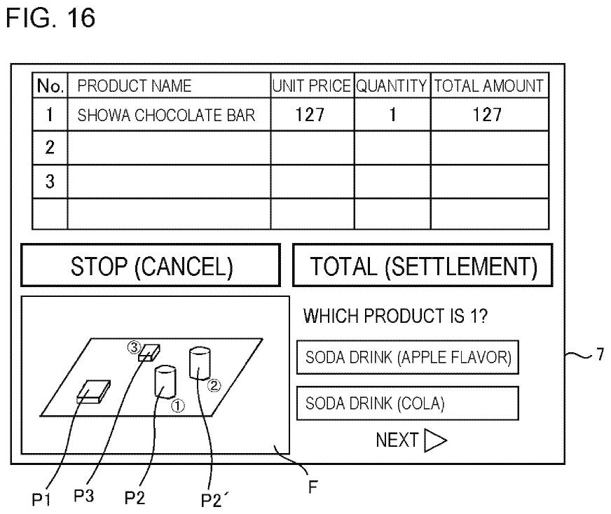

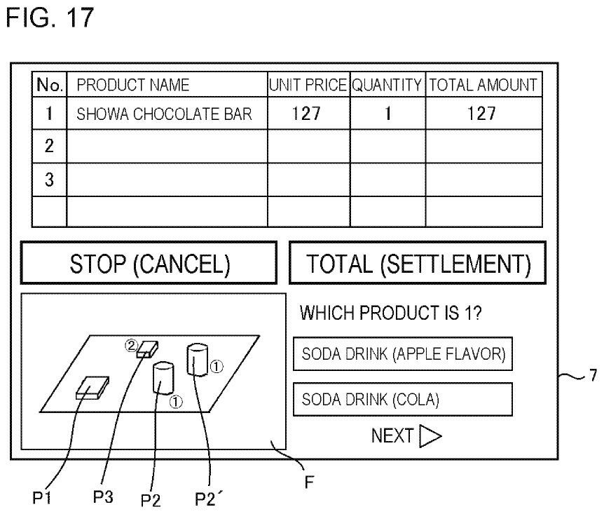

As illustrated in FIG. 16, the registration system 10 according to the present example embodiment displays identification information issued corresponding to each as the first information for determining an object which is not recognized by the recognition unit 12 as a product. As illustrated in FIG. 17, the registration system 10 according to the present example embodiment can assign the same identification information to a plurality of objects based on a user input. This point is different from the first to fourth example embodiments.

An example of a hardware configuration of the registration system 10 according to the present example embodiment has the same manner as that of the first to fourth example embodiments.

An example of a functional block diagram of the registration system 10 is illustrated in FIG. 9. As illustrated, the registration system 10 includes the detection unit 11, the recognition unit 12, the display unit 13, the registration unit 14, the selection input reception unit 15, and a switching input reception unit 16. Configurations of the detection unit 11, the recognition unit 12, and the selection input reception unit 15 have the same manner as those in the first and fourth example embodiments.

As illustrated in FIG. 16, the display unit 13 displays identification information issued corresponding to each as the first information for determining the object which is not recognized by the recognition unit 12 as the product, on the image F of the first display 7. The identification information is configured with, for example, numbers, characters, marks, figures, and the like.

The switching input reception unit 16 receives a user input (a grouping input) of displaying one piece of identification information which determines M objects (M is equal to or more than two) of the objects which are not recognized by the recognition unit 12 as the products. The grouping input may be, for example, an operation of tapping display areas of a plurality of pieces of identification information (or display areas of the products) at the same time in a state illustrated in FIG. 16. Note that, a content of the touch operation is a matter of design.

The display unit 13 switches a display content of the first information according to the grouping input. For example, in the state illustrated in FIG. 16, when an operation (the grouping input) for assigning the identical identification information to the products P2 and P2′ is received, the display unit 13 changes the display content as illustrated in FIG. 17. In FIG. 17, the same identification information (a circle 1) is displayed in association with the placement position of the product P2 and the placement position of the product P2′.

The display unit 13 displays the product candidates for the plurality of objects determined by the one piece of identification information, on the first display 7. For example, the display unit 13 can display a product which is the product candidate for one of the plurality of objects determined by the one piece of identification information, as a product candidate.

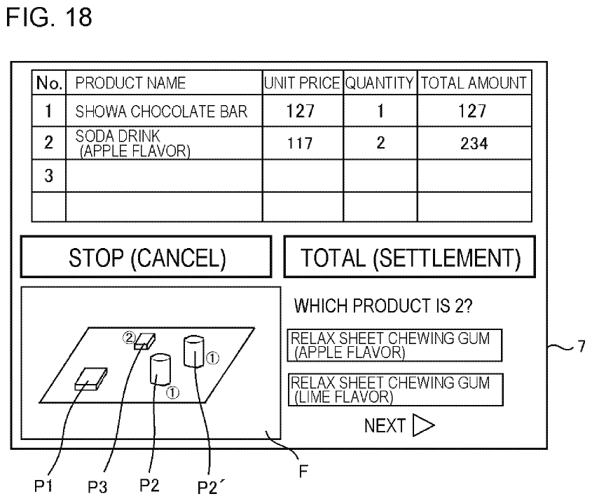

When the selection input reception unit 15 receives the selection input of selecting one of the product candidates in a state in which one piece of identification information (the first information) of determining the M objects (M is equal to or more than two) is displayed, the registration unit 14 registers the selected product candidate for the M objects as the checkout targets (see FIG. 18).

Other configurations of the display unit 13, the display unit 13, the registration unit 14, and the switching input reception unit 16 have the same manner as those of the first to fourth example embodiments.

The registration system 10 according to the present example embodiment described above allows the same advantageous effect as the first to fourth example embodiments to be achieved. Further, the registration system 10 according to the present example embodiment makes, in a case where a plurality of identical products are not recognized as products and are not registered as checkout targets, it possible to lump the products together and perform an input of specifying a product candidate. As a result, work efficiency of the user is improved.

Here, a modification example applicable to all the example embodiments will be described. In the modification example, the registration system 10 may not have the second display 2. In this case, the display unit 13 can display the information displayed on the second display 2 in the above-described example embodiments, on a placing surface of the placing table 1 by using a projection apparatus.

The display unit 13 holds in advance a conversion rule for converting “coordinates of an image” into the “coordinates of a projection area of the projection apparatus”. The display unit 13 can convert a position (the coordinates) of an object in the image into the coordinates of the projection area of the projection apparatus based on the conversion rule and project predetermined information to surround the converted position or be close to the position, for example. The coordinates of the projection area of the projection apparatus are represented by a coordinate system in which any position is defined as an origin and any directions are defined as an x-axis direction and a y-axis direction in the projection area.

Note that, a configuration in which without the second display 2, the information displayed on the second display 2 in the above example embodiments is not displayed may be provided.

Further, instead of the image F displayed on the first display 7, the display unit 13 may display a description image which describes a product included in the image F, on the first display 7. The display unit 13 may display the first information on the description image. The description image illustrates a shape and a placement position of the product included in the image F, a relative placement position among a plurality of products, and the like. For example, the description image may be generated by drawing a figure of the shape of the product illustrated in the image F at the placement position illustrated in the image F. The shape of the product illustrated in the image F is determined by a process of analyzing the image and extracting a contour line or the like. Note that, the figure of the shape of the product drawn in the description image may be a shape of the product itself illustrated in the image F or a similar image obtained by processing the shape of the product illustrated in the image F.

Hereinafter, appendixes to examples of reference forms will be added.

1. A registration system including:

a detection unit that detects an object in a captured image obtained by a camera imaging a placing surface of a table on which a product is placed;

a recognition unit that recognizes which product the object is;

a display unit that displays information for determining the object that cannot be recognized and a product candidate for the object on a display;

a selection input reception unit that receives a selection input for selecting one from the product candidates; and

a registration unit that registers the recognized product and the selected product candidates as checkout targets.

2. The registration system according to appendix 1,

in which the display unit displays the captured image on the display, and displays information for determining the object that cannot be recognized on the captured image.

3. The registration system according to appendix 1,

in which the display unit displays a description image which describes the product included in the captured image on the display, and displays information for determining the object that cannot be recognized on the description image.

4. The registration system according to any one of appendixes 1 to 3,

in which the display unit distinguishably displays a plurality of the objects that cannot be recognized, and displays the product candidates on the display for each of the objects that cannot be recognized.

5. The registration system according to any one of 1 to 3,

in which the display unit displays information for determining one of a plurality of the objects that cannot be recognized and the product candidate for the determined object on the display.

6. The registration system according to any one of appendixes 1 to 5,

in which the product candidate is determined based on a recognition result by the recognition unit.

7. The registration system according to any one of 1 to 6,

in which the display unit displays M objects (M is equal to or more than two) of a plurality of the objects that cannot be recognized in association with each other, and displays the product candidates for the M objects on the display, and

when the selection input reception unit receives a selection input for selecting one of the product candidates for the M objects, the registration unit registers the selected product candidates for the M objects as the checkout targets.

8. A registration method executed by a computer, the method including:

a detection step of detecting an object in a captured image obtained by a camera imaging a placing surface of a table on which the product is placed;

a recognition step of recognizing which product the object is;

a display step of displaying information for determining the object that cannot be recognized and a product candidate for the object on a display;

a selection input reception step of receiving a selection input for selecting one from the product candidates; and

a registration step of registering the recognized product and the selected product candidate as checkout targets.

9. A program causing a computer to function as:

a detection unit that detects an object in a captured image obtained by a camera imaging a placing surface of a table on which a product is placed;

a recognition unit that recognizes which product the object is;

a display unit that displays information for determining the object that cannot be recognized and a product candidate for the object on a display;

a selection input reception unit that receives a selection input for selecting one from the product candidates; and

a registration unit that registers the recognized product and the selected product candidate as checkout targets.

This application claims priority based on Japanese Patent Application No. 2018-054102, filed on Mar. 22, 2018, the disclosure of which is incorporated herein in its entirety.

1. A registration system comprising:
at least one memory configured to store instructions; and
at least one processor configured to execute the instructions to:
detect an object in a captured image including a placing surface of a table on which a product is placed;
recognize a product based on the detected object;
display information for determining the object that has not been recognized and product candidates for the object that has not been recognized on a display;
receive a selection input for selecting one from the product candidates; and
register the recognized product and the selected product candidate as checkout targets.

2. The registration system according to claim 1, wherein the processor is further configured to execute the instructions to:
display the captured image on the display; and
display information for determining the object that has not been recognized on the captured image.

3. The registration system according to claim 1, wherein the processor is further configured to execute the instructions to:
display a description image which describes the product included in the captured image on the display; and
display information for determining the object that has not been recognized on the description image.

4. The registration system according to claim 1, wherein the processor is further configured to execute the instructions to the distinguishably display a plurality of the objects that has not been recognized, and display the product candidates on the display for each of the objects that has not been recognized.

5. The registration system according to claim 1, wherein the processor is further configured to execute the instructions to display information for determining one of a plurality of the objects that has not been recognized and the product candidate for the determined object on the display.

6. The registration system according to claim 1, wherein the processor is further configured to execute the instructions to determine the product candidates based on the recognition result.

7. The registration system according to claim 1,
wherein the processor is further configured to execute the instructions to:
display two or more objects that has not been recognized in association with each other;
display the product candidates for the two or more objects on the display; and
in response to receiving a selection input for selecting one of the product candidates for the two or more objects, register the selected product candidates for the two or more objects as the checkout targets.

8. A registration method executed by a computer, the method comprising:
of detecting an object in a captured image including a placing surface of a table on which the product is placed;
recognizing a product based on the detected object;
displaying information for determining the object that has not been recognized and product candidates for the object on a display;
receiving a selection input for selecting one from the product candidates; and
registering the recognized product and the selected product candidate as checkout targets.

9. A non-transitory storage medium storing a program causing a computer to:
detect an object in a captured image including a placing surface of a table on which a product is placed;
recognize a product based on the detected object;
display information for determining the object that has not been recognized and product candidates for the object on a display;
receive a selection input for selecting one from the product candidates; and
register the recognized product and the selected product candidate as checkout targets.

10. The registration system according to claim 1, wherein the processor is further configured to execute the instructions to:
detect an area in which the object exists by using image recognition.

11. The registration system according to claim 10, wherein the processor is further configured to execute the instructions to:
recognize the product based on a feature of the detected area.
